(19) United States
(12) Patent Application Publication
(10) Pub. No.: US 2007/0113097 A1
(43) Pub. Date: May 17, 2007

(54) [STORAGE MEDIA]

(75) Inventor: Chih-Ling Wang, TAIPEI (TW)

Correspondence Address: PHISON ELECTRONICS CORPORATION, 2F-4. NO. 148, SEC. 4, CHUNG HSIAO EAST ROAD, TAIPEI, TW

(73) Assignee: PHISON ELECTRONICS CORP., Chutung Town, Hsinchu Hsien (TW)

(21) Appl. No.: 11/164,253

(22) Filed: Nov. 16, 2005

(51) Int. Cl. H04K 1/00

(52) U.S. Cl. 713/186

(57) ABSTRACT

A storage media is provided. The storage media comprises a user biological feature matching means and a smart card; wherein a user's biological feature is used as password to access the storage media and the smart card is used to encrypt/decrypt data stored in the storage media to effectively protect the data stored in the storage media.

### BACKGROUND OF INVENTION

1. Field of the Invention

The present invention generally relates to a storage media, and more particularly to a storage media comprising a user's biological feature matching means and a smart card for encrypting/decrypting data.

2. Description of Related Art

In the modern rapid development of computer technology, people enjoy using computer many purposes including business as well as pleasure. Now-a-days, computer has become an indispensable tool, which can almost handle everything including saving or processing important data files. Generally, password is used to secure the user's important information, however hackers may still access such information, and therefore the conventional access security is insufficient to protect important information effectively. There information may be at high risk of being stolen by hackers with the special tool even when users' passwords are not decoded. Besides, if a user forgets the password, the user cannot access the information and thereby causing inconvenience to the user.

Nowadays, computers are developed to achieve more powerful calculation capability, faster speed and smaller size, and number and size of the connection ports of the computer for connecting to the peripheral devices, for example, the memory device, the hard disk, the ROM and other devices, are also correspondingly reduced. Therefore, the use of, for example, external hub, memory stick and external hard disk, has become highly popular as this would allow reduction in the number of the connection ports. The user can store the information into a computer or a PDA or a memory card, and use the computer or PDA to read the information stored in the memory card. The current trend of minimizing size of the electronic devices increases the possibility of misplacing the small size electronic devices, and therefore the possibility of loosing important information is increased.

Recently, some manufacturers proposed replacing the conventional password identification means with biological identification means, such as identifying users' fingerprint, face and the like. Because biological features are quite unique that can not be imitated, the biological features may be comparatively safer method of protecting the important information. Nevertheless, there still exist several defects in this method as information may still be stolen by using special tools or during the transmission such information.

For overcoming the above defects, some manufacturers developed smart card to encode information where only the user's exclusive key can be used to decode and access to the information. But still, there is a possibility of stealing the key of the smart card to steal the important information.

Therefore, how to overcome the above defects of the conventional art is an important issue for the manufacturers in the field.

### SUMMARY OF THE INVENTION

According to an aspect of the present invention, a user's biological feature is used as password to access a storage media and a smart card is used to encrypt/decrypt data stored in the storage media to substantially reduce the possibility of a hacker from accessing the data stored in the storage media.

### BRIEF DESCRIPTION OF THE DRAWING

FIG. 1 is a block diagram of a storage media according to an embodiment of the present invention.

FIG. 2 is a block diagram of a storage media according to another embodiment of the present invention.

FIG. 3 is a flowchart (I) illustrating the operation of a storage media according to an embodiment of the present invention.

FIG. 4 is a flowchart (II) illustrating the operation of a storage media according to another embodiment of the present invention.

### DETAILED DESCRIPTION OF THE EMBODIMENTS

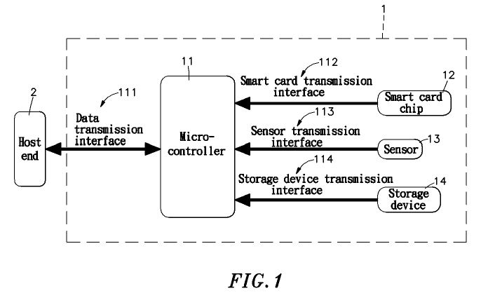

Referring to FIG. 1, a storage media 1 of the present invention comprises a microcontroller 11, a smart card chip 12, a sensor 13 and a storage device 14.

The microcontroller 11 is adopted for controlling the storage media 1. The microcontroller 11 is electrically connected to a data transmission interface 111, a smart card transmission interface 112, a sensor transmission interface 113 and a storage device transmission interface 114. The data transmission interface 111 is adopted for connecting to a host end 2. The host end 2 may be comprised of a desktop computer, a notebook computer or a PDA.

The smartcard chip 12 is electrically connected to the smart card transmission interface 112 of the microcontroller 11. The smart card chip 12 is adopted for encrypting and decrypting data stored in the storage device 14 or may also function as a payment tool. The above encrypting/decrypting method may be advanced encryption standard (AES), data encryption standard (DES), rivest shamir adleman encryption (RSA) or triple data encryption algorithm (3DES).

The sensor 13 is electrically connected to the sensor transmission interface 113 of the microcontroller 11. The sensor 13 is adopted for inputting an image of a user's biological feature. The sensor 13 may be piezoelectric sensor, capacitive sensor, optical sensor or thermal sensor. The biological feature may be a fingerprint or a face outline.

The storage device 14 is electrically connected to the storage device transmission interface 114 of the microcontroller 11, and is adopted for storing data, programs or key. The storage device 14 may be a flash memory or a hard disk.

The storage media 1 may further comprise an auto-execution program so that when the storage media 1 is electrically connected to the host end 2, a password verification program can be automatically executed.

When a user wishes to retrieve data or programs stored in the storage media 1, the data transmission interface 111 of the storage media 1 is electrically connected to the host end 2, and the microcontroller 11 requests the user to input an exclusive key and a biological feature via the sensor 13. After the user inputs the exclusive key and the biological feature via the sensor 13, the microcontroller 11 transmits the biological feature received by the sensor 13 to the host end 2 for reconstruction of a image and then match the reconstructed image with a biological feature stored in the storage media 1; and the exclusive key inputted by the user is also compared with a key stored in the storage media 1. If the key and the biological feature inputted by the user match with the key and the biological feature stored in the storage media 1, the host end 2 allowed to access the data or programs stored in storage device 14. When the host 2 retrieves the data from the storage device 14, the smart card chip 12 will decrypt the data, and the decrypted data is transmitted by the microcontroller 11 to the host end 2. When the host end 2 writes data into the storage device 14, the smart card chip 12 will encrypt the data and then transmits the encrypted data to the storage device 14 for storage. Besides, the smart card chip 12 is also adopted for adding/deducting values or points enabling the user to purchase, add values and verify identity through the Internet.

Further, when the user inputs the exclusive key and the biological feature via the sensor 13, the storage media 1 can also use the microcontroller 11 to reconstruct the image of the biological feature received by the sensor 13, and then compares the reconstructed image with the biological feature stored in the storage device 14; and the key inputted by the user is also compared with the key stored in the storage device 14. If the key and the biological feature match with the key and the biological feature stored in the storage media 1, the host end 2 is allowed to access the data stored in the storage media 1.

Accordingly, when the inputted biological feature does not match with the biological feature stored in the storage media 1, access to the data stored in the storage media 1 is denied. Furthermore, even if an unauthorized user tries to use a special tool to steal the data stored in the storage device 14, the unauthorized user would not be able to decrypt the data because he doesn't input the user's exclusive key. Thus, the data stored in storage media 1 can be effectively protected. The user' biological feature or key may be stored in the host end 2 or the storage device 14 of the storage media 1. The storage media 1 may be a portable memory stick, a memory card or a hard disk.

Furthermore, the data transmission interface 111 may be USB transmission interface or SATA transmission interface. The smart card transmission interface 112 may be an ISO 7816-3 transmission protocol or a serial peripheral interface (SPI).

Furthermore, the sensor transmission interface 113 may be parallel or serial transmission interface. The storage device transmission interface 114 may be a flash memory transmission interface or a hard disk transmission interface.

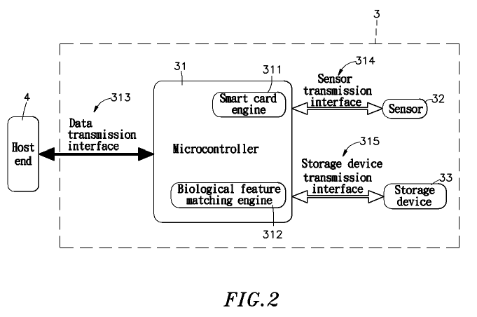

Referring to FIG. 2, a storage media 3 comprises a microcontroller 31, a sensor 32 and a storage device 33.

The microcontroller 31 is adopted for controlling the storage media 3. The microcontroller 31 comprises a smart card engine 311 and a biological feature matching engine 312. The microcontroller 31 is electrically connected to a data transmission interface 313, a sensor transmission interface 314 and a storage device transmission interface 315. The data transmission interface 313 is adopted for electrically connecting to a host end 4. The host end 4 may be a desktop computer, a notebook computer or a PDA.

The sensor 32 is electrically connected to the sensor transmission interface 314 of the microcontroller 31. The sensor 32 is adopted for inputting an image of the user's biological feature. The sensor 32 may be a piezoelectric sensor, a capacitive sensor, an optical sensor or a thermal sensor. The biological feature may be a fingerprint or a face outline.

The storage device 33 is electrically connected to the storage device transmission interface 315 of the microcontroller 31 and is adopted for storing data, programs or keys. The storage device 33 may be a flash memory or a hard disk.

When a user wishes to retrieve data stored in the storage media 3, the data transmission interface 313 of the storage media 3 is electrically connecting to the host end 4, and the microcontroller 31 requests the user to input an exclusive key and a biological feature via the sensor 32. After the user inputs the exclusive key and the biological feature via the sensor 32, the microcontroller 31 transmits the biological feature to the biological feature matching engine 312 for reconstructing of a image and then comparing the reconstructed image with a biological feature stored in the storage media 3. After the biological feature inputted by the user matches with the biological feature stored in the storage media 3, the microcontroller 31 will operate the smart card engine 311 to match the exclusive key inputted by the user with a key stored in the storage media 3. If the key and the biological feature inputted by the user match with the key and the biological feature stored in the storage media 3, the user is allowed to access the information stored in the storage media 3 via host end 4. When the host end 4 retrieves the data from the storage device 33, the smart card engine 311 will decrypt the data, and the decrypted data is then transmitted by the microcontroller 31 to the host end 4. When the host end 4 writes data into the storage device 33, the smart card engine 311 will encrypt the data and then transmits the encrypted data to the storage device 33 for storage. Furthermore, the smart card engine 311 is also adopted for adding/deducting value or points to enable the user to purchase, add value and verify identity through the Internet.

The above encrypting/decrypting method of the smart card engine 311 may be advanced encryption standard (AES), data encryption standard (DES), rivest shamir adleman encryption (RSA) or triple data encryption algorithm (3DES).

Furthermore, the storage media 3 may be a portable memory stick, a memory card or a hard disk. The data transmission interface 313 may be a USB transmission interface or a SATA transmission interface.

Furthermore, the sensor transmission interface 314 may be a parallel or a serial transmission interface. The storage device transmission interface 315 may be a flash memory transmission interface or a hard disk transmission interface.

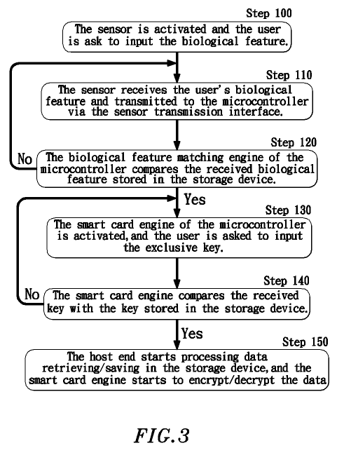

Hereinafter, the operation of the storage media 3 is described with reference to FIGS. 2 and 3 as follows.

At step 100, the sensor 32 is activated and the user is asked to input the biological feature.

At step 110, the sensor 32 receives the user's biological feature and then transmitted to the microcontroller 31 via the sensor transmission interface 314.

At step 120, the biological feature matching engine 312 of the microcontroller 31 compares the received biological feature with the biological feature stored in the storage device 33, if the two biological features match, the procedure proceeds to step 130, otherwise the procedure returns to step 110.

At step 130, the smartcard engine 311 of the microcontroller 31 is activated, and the user is asked to input the exclusive key.

At step 140, the smart card engine 311 compares the received exclusive key with the key stored in the storage device 33, if the two keys match, the procedure proceeds to step 150, otherwise procedure continues to ask the user to input the key (step 140).

At step 150, the host end 4 starts processing data retrieving/saving in the storage device 33, and the smart card engine 311 starts to encrypt/decrypt the data.

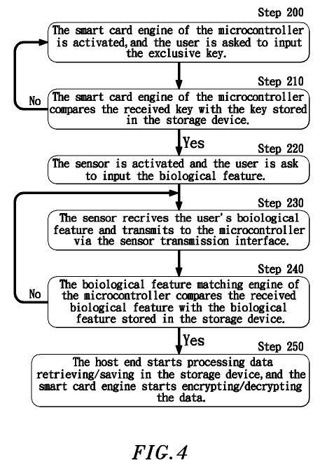

Hereinafter, the operation of the storage media 3 is described with reference to FIGS. 2 and 4 as follows.

At step 200, the smart card engine 311 of the microcontroller 31 is activated, and the user is asked to input the exclusive key.

At step 210, the smart card engine 311 of the microcontroller 31 compares the received exclusive key with the key stored in the storage device 33, if the two keys match, the procedure proceeds to step 220, otherwise the procedure returns to step 200.

At step 220, the sensor 32 is activated and the user is asked to input the biological feature.

At step 230, the sensor 32 receives the user's biological feature and then transmits to the microcontroller 31 via the sensor transmission interface 314.

At step 240, the biological feature matching engine 312 of the microcontroller 31 compares the received biological feature with the biological feature stored in the storage device 33, if the two biological features match, the procedure proceeds to step 250, otherwise procedure returns to step 230.

At step 250, the host end 4 starts processing data retrieving/saving in the storage device 33, and the smartcard engine 311 starts encrypting/decrypting the data.

Thus, as described above, the storage media of the present invention is more advantageous compared to conventional art by way of using user's unique biological feature as the password to access to the storage media to prevent the unauthorized user to access and process the important data stored in the storage media, in addition, a smart card is used to encrypt/decrypt the data to avoid the unauthorized user to steal the data from the storage device of the storage media. Thus, the data stored in the storage media can be effectively protected.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A storage media, comprising:
a microcontroller, comprising a smart card engine and a biological feature matching engine, wherein said microcontroller is electrically connected to a data transmission interface, a sensor transmission interface and a storage device transmission interface and said data transmission interface is electrically connected to a host end;
a sensor, electrically connected to said sensor transmission interface of said microcontroller, adopted for inputting an image of users' biological feature; and
a storage device, electrically connected to said storage device transmission interface of said microcontroller, wherein when said storage media is electrically connected to said host end via said data transmission interface, said microcontroller asks a user to input an exclusive key and a biological feature via said sensor, said biological feature matching engine and said smart card engine of said microcontroller compare said inputted biological feature and said exclusive key with a biological feature and a key stored in said storage media, and when said exclusive key and said biological feature inputted by said user match with said key and said biological feature stored in said storage media, said user is allowed to access said storage device via host end to retrieve/store data from/to the storage device, and said smart card engine encrypts/decrypts said retrieved/stored data.

2. The storage media as claimed in claim 1, wherein said storage media comprises a portable memory stick, a memory card or a hard disk.

3. The storage media as claimed in claim 1, wherein said data transmission interface comprises a USB transmission interface or a SATA transmission interface.

4. The storage media as claimed in claim 1, wherein said sensor comprises a piezoelectric sensor, a capacitive sensor, an optical sensor or a thermal sensor.

5. The storage media as claimed in claim 1, wherein said biological feature comprises a fingerprint or a face outline.

6. The storage media as claimed in claim 1, wherein said host end comprises a desktop computer, a notebook computer or a PDA.

7. The storage media as claimed in claim 1, wherein said encrypting/decrypting method of said smart card engine comprises an advanced encryption standard (AES), a data encryption standard (DES), a rivest shamir adleman encryption (RSA) or a triple data encryption algorithm (3DES).

8. A storage media, comprising:
a microcontroller, electrically connected to a data transmission interface, a smart card transmission interface, a sensor transmission interface and a storage device transmission interface, wherein said data transmission interface is electrically connected to a host end;
a sensor, electrically connected to a sensor transmission interface of said microcontroller, adopted for inputting an image of users' biological feature;
a storage device, electrically connected to said storage device transmission interface of said microcontroller, adopted for storing data, programs or key; and
a smart card chip, electrically connected to said smart card transmission interface of said microcontroller, adopted for encrypting/decrypting data stored in said storage device, wherein when said storage media is electrically connected to said host end via said data transmission interface, said microcontroller asks a user to input an exclusive key and a biological feature via said sensor, said microcontroller transmits said exclusive key and said biological feature to said host end, said host end compares said exclusive key and said biological feature inputted by said user with a key and a biological feature stored in said host end, wherein if said exclusive key and said biological feature inputted by said user match with said key and said biological feature stored in said host end, said user is allowed to access said storage device via said host end to retrieve/store data from/to the storage device, and said smart card chip encrypts/decrypts said retrieved/stored data.

9. The storage media as claimed in claim 8, wherein said storage media comprises a portable memory stick, a memory card or a hard disk.

10. The storage media as claimed in claim 8, wherein said data transmission interface comprises a USB transmission interface or a SATA transmission interface.

11. The storage media as claimed in claim 8, wherein said host end comprises a desktop computer, a notebook computer or a PDA.

12. The storage media as claimed in claim 8, wherein said sensor comprises a piezoelectric sensor, a capacitive sensor, an optical sensor or a thermal sensor.

13. The storage media as claimed in claim 8, wherein said biological feature comprises a fingerprint or a face outline.

14. The storage media as claimed in claim 8, wherein said encrypting/decrypting method of said smart card chip comprises an advanced encryption standard (AES), a data encryption standard (DES), a rivest shamir adleman encryption (RSA) or a triple data encryption algorithm (3DES).

15. The storage media as claimed in claim 8, wherein said storage device comprises a flash memory or a hard disk.

16. The storage media as claimed in claim 8, wherein said storage media further comprises an auto-execution program so that when said storage media is electrically connected to said host end, a password verification program is automatically executed.

17. The storage media as claimed in claim 8, wherein said smart card chip is adopted for adding/deducting value or points function.

18. A storage media, comprising:
a microcontroller, electrically connected to a data transmission interface, a smart card transmission interface, a sensor transmission interface and a storage device transmission interface, wherein said data transmission interface is electrically connected to a host end;
a sensor, electrically connected to said sensor transmission interface of said microcontroller, adopted for inputting an images of users' biological feature;
a storage device, electrically connected to said storage device transmission interface of said microcontroller, adopted for storing data, programs or key; and
a smartcard chip, electrically connected to said smart card transmission interface of said microcontroller, adopted for encrypting/decrypting data stored in said storage device, wherein when said storage media is electrically connected to said host end via said data transmission interface, said microcontroller asks a user to input an exclusive key and a biological feature via said sensor, said microcontroller compares said exclusive key and said biological feature inputted by said user with a key and a biological feature stored in said storage device, wherein if said exclusive key and said biological feature inputted by said user match with said key and said biological feature stored in said storage device, said user is allowed to access said storage device via said host end to retrieve/store data from/to said storage device, and said smart card chip encrypts/decrypts said retrieved/saved data.

19. The storage media as claimed in claim 18, wherein said storage media comprises a portable memory stick, a memory card or a hard disk.

20. The storage media as claimed in claim 18, wherein said data transmission interface comprises a USB transmission interface or a SATA transmission interface.

21. The storage media as claimed in claim 18, wherein said host end comprises a desktop computer, a notebook computer or a PDA.

22. The storage media as claimed in claim 18, wherein said sensor comprises a piezoelectric sensor, a capacitive sensor, an optical sensor or a thermal sensor.

23. The storage media as claimed in claim 18, wherein said biological feature comprises a fingerprint or a face outline.

24. The storage media as claimed in claim 18, wherein said encrypting/decrypting method of said smart card chip comprises an advanced encryption standard (AES), a data encryption standard (DES), a rivest shamir adleman encryption (RSA) or a triple data encryption algorithm (3DES).

25. The storage media as claimed in claim 18, wherein said storage device comprises a flash memory or a hard disk.

26. The storage media as claimed in claim 18, wherein said storage media further comprises an auto-execution program so that when said storage media is electrically connected to said host end, a password verification program is automatically executed.

27. The storage media as claimed in claim 18, wherein said smart card chip is adopted for adding/deducting value or points function.
